(19) United States
(12) Patent Application Publication
(10) Pub. No.: US 2019/0368461 A1
(43) Pub. Date: Dec. 5, 2019

(54) Wave Energy Converting Systems Using Internal Inertias and Optimized Floating Bodies Having a Water Head That Drives a Water Turbine at Stable Speed

(71) Applicant: Murtech, Inc., Glen Burnie, MD (US)

(72) Inventors: Umesh A. KORDE, Hanover, MD (US); Michael E. MCCORMICK, Annapolis, MD (US); Robert C. MURTHA, JR., Stevensville, MD (US)

(21) Appl. No.: 16/420,304

(22) Filed: May 23, 2019

Related U.S. Application Data
(60) Provisional application No. 62/677,915, filed on May 30, 2018.

(51) Int. Cl. F03B 13/22; F03B 13/14

(52) U.S. Cl. CPC F03B 13/22; F03B 13/148

(57) ABSTRACT

Wave energy conversion systems (WECS) with internal power take-off mechanisms using internal inertias as well as WECS using a submerged water head for driving a turbine at a steady rate. The WECS involving internal inertias is effected through relative oscillation between masses inside the hull of watercraft excited by wave motion and whereby the masses' oscillations are captured by actuators (e.g., hydraulic) that pressurize a fluid or generate electricity. Different relative oscillation mechanisms are disclosed herein. The WECS involving a submerged water head involve the use of asymmetric floats, arranged in a circular orientation for omni-directional wave energy capturing, that drive respective pistons that pressurize the water head and drive the turbine. Alternatively, the use of articulating raft/barges or floats coupled via a lever arm can be used instead of the asymmetric floats for pressurizing the water head.

### CROSS-REFERENCE TO RELATED APPLICATIONS

This Non-provisional application claims the benefit under 35 U.S.C. § 119(e) of Provisional Application Ser. No. 62/677,915 filed on May 30, 2018 entitled WAVE ENERGY CONVERTING SYSTEMS USING INTERNAL INERTIAS AND OPTIMIZED FLOATING BODIES HAVING A WATER HEAD THAT DRIVES A WATER TURBINE AT STABLE SPEED and whose entire disclosure is incorporated by reference herein.

### BACKGROUND OF THE INVENTION

The present invention relates in general to wave energy conversion systems and, more particularly, to wave energy converters that utilize internal inertias or a submerged water head for driving a turbine at a stable speed.

Richard Peter McCabe devised the McCabe Wave Pump, which is described in U.S. Pat. No. 5,132,550. The McCabe Wave Pump consists of three rectangular steel pontoons, which move relative to each other in the waves. A damper wave plate attached to the central pontoon ensures that it remains stationary as the fore and aft pontoons move relative to the central pontoon by pitching about the hinges. Energy is extracted from the rotation about the hinge points by linear hydraulic pumps mounted between the central and other two pontoons near the hinges.

A related configuration to the McCabe Wave Pump is an “articulating wave energy conversion system” (AWECS) which is disclosed in U.S. Pat. No. 8,778,176 (Murtha, et al.); U.S. Pat. No. 8,784,653 (Murtha, et al.); U.S. Pat. No. 8,866,321 (McCormick, et al.); U.S. Pat. No. 9,334,860 (Knowles, Jr., et al.); and U.S. Pat. No. 9,702,334 (Murtha, Jr., et al.), and all of which are owned by the same Assignee as the present application, namely, Murtech, Inc. of Glen Burnie, Md. See also U.S. Pat. No. 8,650,869 (McCormick).

Other types of wave energy converters (WECs) involving WECs having internal power take-off mechanisms are discussed in the following:
Babarit, A., Clement, A. H., Gilloteaux, J-C. ‘Optimization and time-domain simulation of the SEAREV wave energy converter’, 24th ASME Int. Offshore Mechanics and Arctic Engineering Conference, Halkidiki, Greece, June, 2005;
French, M. J. and Bracewell, R. H. ‘Heaving point absorbers reacting against an internal mass’, Proc. IUTAM Symposium On Hydrodynamics Of Ocean Wave Energy Utilization, Lisbon, Portugal, July, 1985;
Korde, U. A. ‘Study of a wave energy device for possible application in communication and spacecraft propulsion’, Ocean Engineering, v. 17, n. 6, 1990;
Korde, U. A. ‘On providing a reaction for efficient wave energy absorption by floating devices’, Applied Ocean Research, v. 21, n. 6, 1999;
Korde, U. A. ‘Making small wave energy devices cost effective for underwater microgrids through a 10-fold increase in year-round productivity’, Final report, DARPA, April 2017;
Longuet-Higgins, M. S. ‘Statistical properties of wave groups in a random sea state’, Phil. Trans. of the Royal Society of London, Series A, v. 249, 1957;
McShane, W. ‘Potential maritime markets for marine and hydrodynamic technologies’, DOE Office of Energy Efficiency and Renewable Energy Brief, 2018;
Ringwood, J. V., Bacelli, G., Fusco, F. ‘Energy-maximizing control of wave energy converters’, IEEE Control Systems Magazine, October 2014; and
Salter, S. H. ‘The use of gyros as a reference frame in wave energy converters’, 2nd Int. Symposium On Wave Energy Utilization, Trondheim, Norway, December 1982.
   These systems were designed to utilize an internal inertia to serve as a reference for the wave-excited oscillations of the body containing them. While the devices in the aforementioned publications may be generally suitable for their intended purposes, these systems tended to require heavy internal inertias.

Furthermore, it should be noted that the use of water turbines in wave energy conversion dates back at least to the late 1970s when it was proposed for the Vickers submerged resonant U-tube device (Lighthill, 1979), and when bathymetry-driven progressive focusing of waves in shallow waters was used to produce a head of water in a dam to sustain flow over a hydroelectric turbine (Mehlum, 1979). This basic idea was later extended to the “Wave Dragon”, a floating “overtopping” system in deeper waters, where focusing and overtopping of crests was achieved using large curving baffles (Friis-Madsen, 2012). However, this system faced challenging structural design requirements, even though the overall efficiency of conversion to electric power was found to be promising (Friis-Madsen, 2012). The particular citations for the above publications are:
Friis-Madsen. E., Sorensen, H. C., Parmeggiani, S., ‘The development of a Wae Dragon 1.5MW demonstrator’, Proc. 4th Int. Conference on Ocean Energy (ICOE), Dublin, October, 2012;
Lighthill, M. J., ‘Two-dimensional analyses related to wave energy extraction by submerged resonant ducts’, J. Fluid Mechanics, v. 91, pp. 253-317; and
Mehlum, E., ‘The TAPCHAN wave energy converter, Proc. 1st Symp. On Wave Energy Utilization, Gothenburg, Sweden, October/November, 1979.

Thus, in view of the foregoing, Applicant/Assignee, Murtech, Inc. of Glen Burnie, Md., has developed improvements to WECs to address the deficiencies described above.

All references cited herein are incorporated herein by reference in their entireties.

### BRIEF SUMMARY OF THE INVENTION

A system for converting wave energy from a body of water having waves (e.g., ocean, sea, fresh water, etc.) into usable energy is disclosed. The system comprises: a watercraft floatable in the body of water and having an enclosure therein, wherein the enclosure has an interior that is isolated from physical contact with the body of water; at least one mass that is disposed in the enclosure such that it can reciprocate in motion in response to the wave energy; a biasing means (e.g., a spring) interfaced with the at least one mass that permits the at least one mass to oscillate; and couplings connected with the at least one mass and to at least one actuator for converting the oscillation into actuator activation to pressurize a fluid or energize an electrical generator.

A method for converting wave energy from a body of water having waves (e.g., ocean, sea, fresh water, etc.) into usable energy is disclosed. The method comprises: providing a watercraft that is floatable in the body of water and having an enclosure therein, wherein the enclosure has an interior that is isolated from physical contact with the body of water; disposing at least one mass in the enclosure such that it can reciprocate in motion in response to the wave energy; interfacing a biasing means with the at least one mass that permits the at least one mass to oscillate; and connecting couplings with the at least one mass and to at least one actuator for converting the oscillation into actuator activation to pressurize a fluid or energize an electrical generator.

A system for converting wave energy from a body of water having waves (e.g., ocean, sea, fresh water, etc.) into usable energy is disclosed. The system comprises: a plurality of floats for capturing wave energy; a piston/cylinder associated with each float, each piston being coupled to a respective float such that wave energy causing the float to heave or pitch causes the piston to displace within the cylinder; a water reservoir submerged in the body water and wherein each cylinder is in fluid communication with the water reservoir; a turbine disposed across an outlet on a bottom side of the reservoir; and activation of the piston towards the water reservoir causing the water in the water reservoir to be pressurized and rotating the turbine.

A method for converting wave energy from a body of water having waves (e.g., ocean, sea, fresh water, etc.) into usable energy is disclosed. The method comprises: disposing a plurality of floats in the body of water for capturing wave energy; associating a piston/cylinder associated with each float wherein each piston is coupled to a respective float such that wave energy causes the float to heave or pitch thereby causing the piston to displace within the cylinder; submerging a water reservoir in the body water and wherein each cylinder is in fluid communication with the water reservoir; disposing a turbine across an outlet on a bottom side of the reservoir; and pressurizing the water in the water reservoir by driving the piston towards the reservoir to rotate the turbine.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A depicts a wave energy converter using internal hull inertias formed of discrete spring-suspended masses that drive respective actuators using pivoting arms;

FIG. 1B depicts another wave energy converter using internal hull inertias formed of a spring-suspended plate coupled to a pivotable platform via a pair of actuators that drive a rotating disk;

FIG. 1C depicts a third wave energy converter using internal hull inertias formed of discrete masses slidably coupled along angled struts with springs disposed both sides of the masses to support oscillation;

FIG. 2A depicts side, top and end views of a wave energy conversion system using a submerged water head for driving a turbine at a steady rate utilizing a plurality of asymmetric floats and respective piston cylinders for pressurizing the water in the submerged water head;

FIG. 2B is an alternative version of the system of FIG. 2A, showing only two floats of a three or four float circular system arrangement;

FIG. 2C is a top view of the system of FIG. 2B showing four exemplary asymmetric floats for omni-directional utility;

FIG. 3A depicts top, side and end views of another wave energy conversion system using a submerged water head for driving a turbine at a steady rate utilizing a pair articulating raft/barges for driving respective piston cylinders for pressurizing the water in the submerged water head;

FIG. 3B depicts top, side and end views of a wave energy conversion system similar to the one in FIG. 3A but using a turbine-generator system fully contained within the reservoir;

FIG. 3C depicts a wave energy conversion system similar to the one in FIG. 3A but depicting an alternative location for the water turbine and where no central barge is used; and

FIG. 4 depicts a third wave energy conversion system using a submerged water head for driving a turbine at a steady rate utilizing a pair of floats coupled in opposition for driving respective piston cylinders for pressurizing the water in the submerged water head.

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

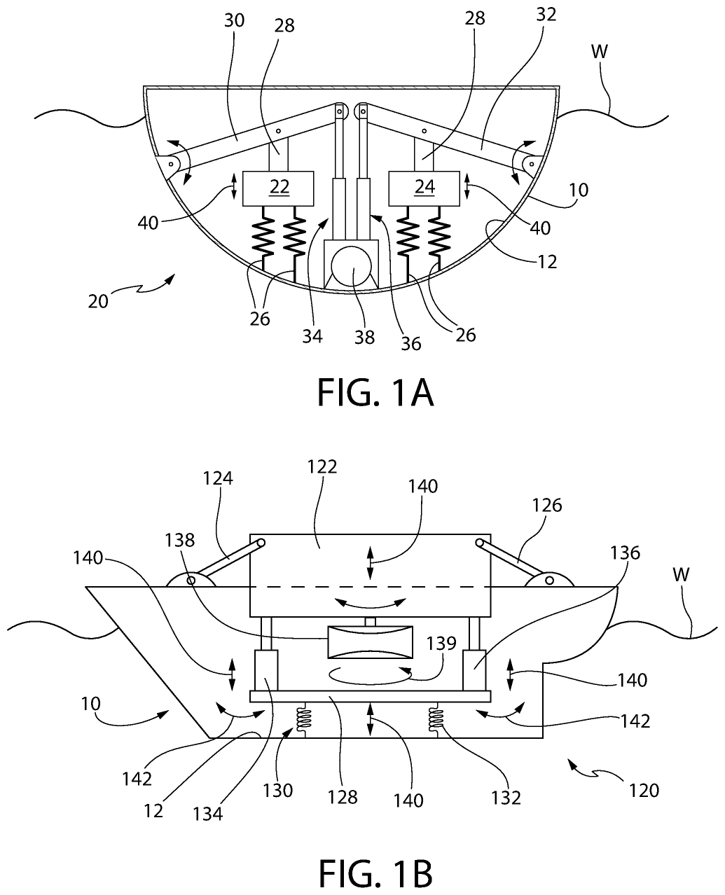

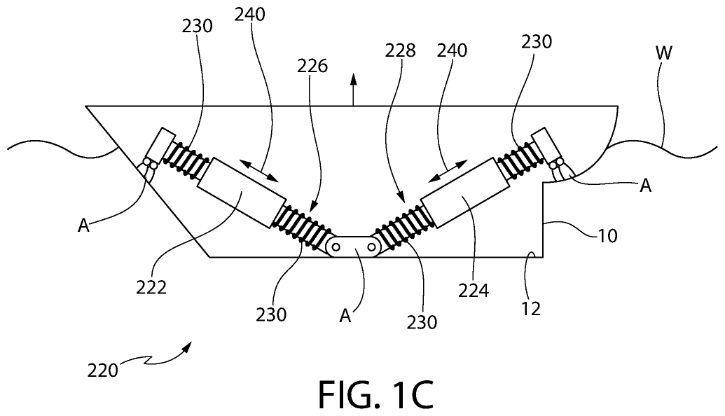

Wave Energy Converters with Internal Power Take-Off Mechanisms (FIGS. 1A-1C)

The following discussion is directed to wave energy converters with internal power take-off mechanisms that provide an economically-attractive power to mass ratio with moderate device oscillations.

As shown in FIGS. 1A-1C, two or more moderately sized internal inertias are used, and the power conversion is effected through relative oscillation between the internal inertias, as driven by the incoming wave fields. Therefore, (i) the relative phases of oscillations and their control for best power conversion become important, while as an added benefit, (ii) the coupled dynamic response of the system is designed to provide two or more resonances that fall within commonly encountered wave spectra. Oscillation control of all bodies, including the wave-excited body, is achieved using resistive and reactive control forces applied on the relative oscillations. Both hydraulic and permanent-magnet electric options are within the broadest scope of the present invention. Since the control objective of optimizing energy conversion through optimal interaction of the outer hull with the waves is met by controlling relative oscillation of the inertias comprising each system, the design of each internal system, the power take-off mechanism and the internal masses are performed concurrently. In addition, the overall mass, buoyancy, and internal volume budgets are to be kept to a minimum so that the converted power/mass ratio targets are achieved.

The embodiments of FIGS. 1A-1C are power take-off approaches that utilize internal inertias for energy conversion from wave-induced heave, pitch, and roll oscillations. Heave and pitch oscillations can be used for conversion with the systems of FIGS. 1A-1C. The system 20 in FIG. 1A uses small centrally-located hydraulic cylinders as actuators, while the system 120 in FIG. 1B uses hydraulic cylinder actuators 134/136 between a central rectangular platform 122, and the spring-supported plate 128 underneath. The oscillating masses 222/224 and the tracks 226/228 in system 220 of FIG. 1C are configured to be integral with a linear generator/motor power take-off (not shown).

The particular advantages of the embodiments shown in FIGS. 1A-1C include: (i) reduced susceptibility to corrosion and bio-fouling since the only element in contact with seawater is the converter outer hull, and (ii) an ability to be easily towed and relocated to different locations on demand, since the system is relatively free of exterior features such as bottom-reacting power take-off systems, drag plates and underwater inertias, submerged actuators, etc. Thus, the embodiments may be towed from one location to another as needed and do not require extended set-up times.

The systems shown in FIGS. 1A-1C are designed for power conversion in the 10-30 kW range, and are designed for operating depths in the range 20-50 m. However, the design of the systems allow them to be scaled up to larger power applications. The embodiments of FIGS. 1A-1C also allow for near-optimal conversion at multiple locations with changes in the internal forces used in achieving the desired dynamic response. The control technique requires impedance matching on a wave-group-by-wave-group basis, and thus only requires nearby or on-board wave measurements. This technique is distinct from wave-by-wave impedance matching, which requires deterministic wave elevation prediction based on wave measurement time series acquired up-wave of the device. Wave-group statistics are computed continually, using an approach originally discussed by Longuet-Higgins (1957). Thus, the systems of FIGS. 1A-1C also enable survival-mode operations (e.g. locking of internal inertial oscillations) to be integrated into the same control formulation as used to provide wave-group-by-wave-group impedance match. While the embodiments of FIGS. 1A-1C are not expected to enable performance at the hydrodynamic optimum, it should be noted that this type of control has not been previously attempted in wave energy conversion. For technical and economic performance comparisons of the embodiments of FIGS. 1A-1C, a previously developed system under wave-by-wave control and pure resistive control (Korde 2017) can be used as a baseline. As mentioned previously, these systems of FIGS. 1A-1C may be towed from one location to another as needed and do not require extended set-up times. The target applications comprise small-medium scale, to serve a range of applications including recharging of underwater vehicles, underwater communications and data transfer, subsea data centers, etc. (McShane, 2018).

To address possible excessive oscillations of the internal masses under resonant conditions, as well as potential instability when energy conversion is active, significant damping, independent of the power take-off, can be added, when needed. This can be effected using a mechanical arrangement such that oscillations exceeding a threshold are maintained within displacement and velocity limits.

Development of the embodiments of FIGS. 1A-1C involved: (1) hydrodynamic design, dynamic design, and power take-off design, (2) dynamic modeling and control in realistic wave climates; (3) computer simulations and wave-tank modeling; (4) energy storage and power flow design, and (5) techno-economic analysis combined with particular applications.

The system 20 of FIG. 1A comprises a pair of masses 22/24 each suspended on biasing members 26 (e.g., springs, etc.) coupled to an internal surface 12 of an enclosure 10 in the watercraft (e.g., a hull). The opposite sides of the masses 22/24 are pivotally connected, via struts 28, to respective pivoting arms 30/32. The arms 30/32 are pivotally connected to the internal surface 12 of the hull 10 at one end, while the other end of the arms 30/32 are pivotally connected to respective rams of actuators 34/36. The actuators 34/36 (e.g., hydraulic actuators, etc.) interface with a hydraulic accumulator 38. Alternatively, the hydraulic actuators 34/36 may comprise linear/electric generators that charge a battery 38. Thus, as the hull 10 experiences wave motion (e.g., heave and pitch motion) in the body of water W, the masses 22/24 are excited and begin to oscillate (in direction 40) thereby respectively oscillating the pivot arms 30/32 to drive the actuators 34/36 (in direction 40) to drive the system fluid or electrical energy to the accumulator/battery, respectively.

The system 120 of FIG. 1B comprises a platform 122 pivotally mounted in a hull 10 using pivotal mounts 124/126 on opposite sides of the platform 122. Beneath the platform 122 and internal to the hull 10, a plate 128 is suspended on springs 130/132, attached to an internal surface 12 of the hull 10, on one side while being coupled to the platform 122 via actuators 134/136 (e.g., hydraulic actuators, etc.) on its other side. A spinning disk 138 is rotatably coupled (arrow 139) to the platform 122 and is driven by actuators’ 134/136 motion; the disk 138 may operate as a flywheel/gyro and stabilizes the platform 122 against roll/pitch, and may be coupled to an electrical generator (not shown). All three components, namely, the hull 10, platform 122 and the plate 128 can oscillate in heave (arrow 140) and pitch (142) as the hull 10 experiences wave motion. The actuators 134/136 use and control the relative oscillation they experience such that (1) power conversion is best when (2) oscillation amplitudes are smaller than actuator limits.

The system 220 of FIG. 1C comprises a pair of masses 222/224 that are slidably mounted on respective angled shafts (or “tracks”) 226/228 that are anchored A to the inside surface 12 of the hull 10. Springs 230 are present on each end of the masses 222/224 to support oscillation of the masses 222/224 in the direction 240. The oscillating motion of the masses 222/224 can be captured in a manner discussed previously with regard to embodiments 20 and 120. Thus, as the hull 10 experiences wave motion (e.g., heave and pitch motion) in the body of water W, the masses 222/224 are excited and oscillate to ultimately drive a hydraulic accumulator or generator and/or charge a battery.

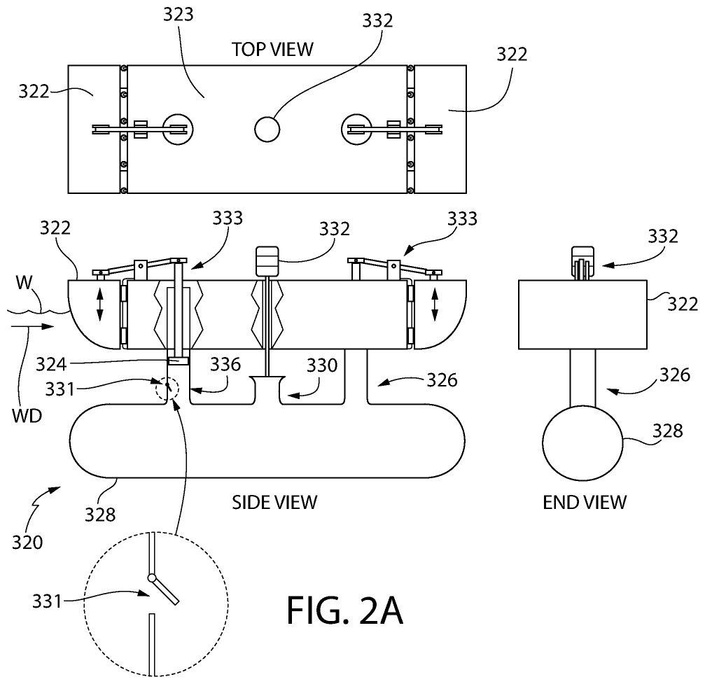

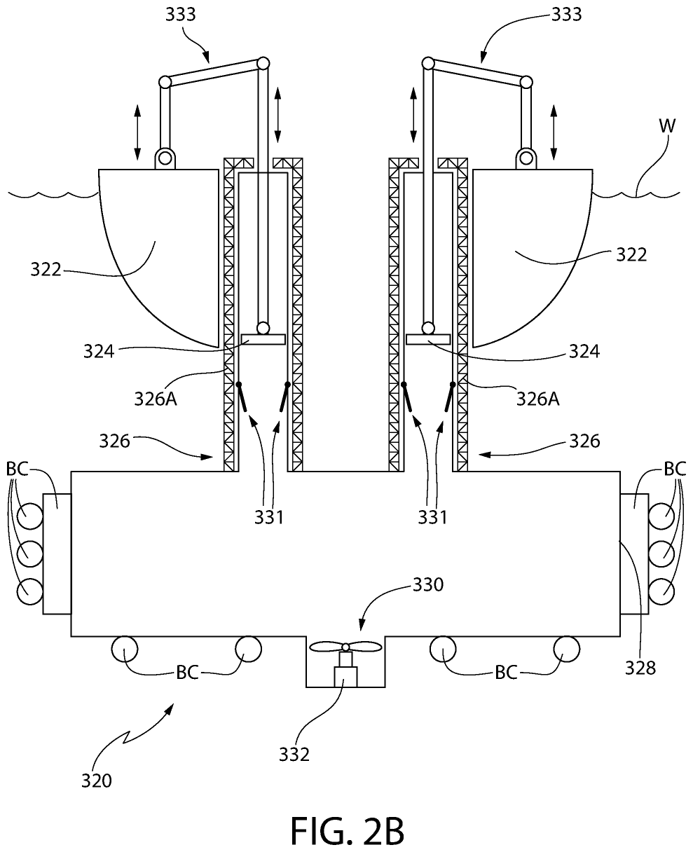

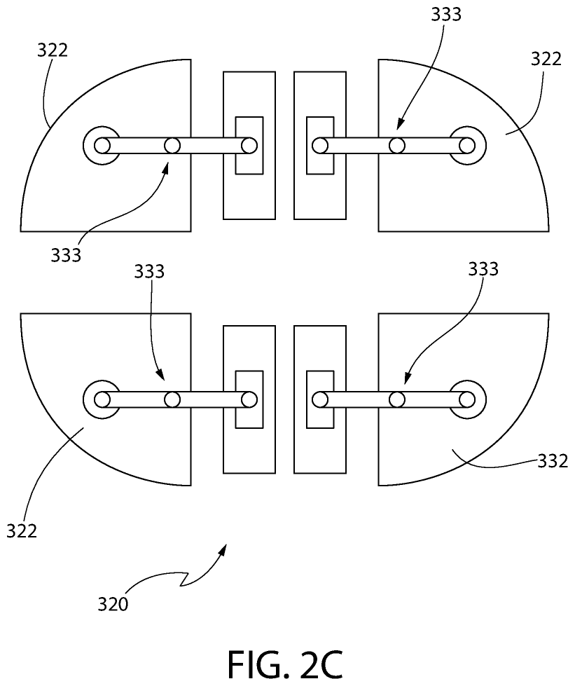

### Wave Energy Converters Using a Submerged Water Head for Driving a Turbine (FIGS. 2A-4)

The WEC embodiments disclosed in this section are based upon the concept that a wave energy converter with the best chance of long-term reliability and cost-effectiveness is one that provides the required power amounts (i) while minimizing the number of interconnecting components in seawater and (ii) while limiting the number of energy conversion stages required. The following embodiments operate where wave-induced oscillations of a hydrodynamically optimized floating body are converted into a head of water that drives a water turbine at a stable rate of speed. The systems in this section attempt to minimize structural loads while seeking favorable dynamic response to approaching wave fields.

FIG. 2A depicts a system 320 where wave-induced oscillations of a float are utilized to pressurize and drive water into a submerged reservoir. The system 320 utilizes wave-excited oscillations of distributed floats 322 (also referred to as “asymmetric floats” due to the asymmetric shape as shown in the side view and in the top view of FIG. 2C). Two floats 322 are used in the system 320 to optimize the system 320 for a predominant wave direction WD. However, it should be understood that alternate implementations, for example using four floats (see FIGS. 2B-2C), located around, and oscillating relative to, a central hub (also referred to as a “support barge”) 323 are also within the broadest scope of this invention to form an omni-directional system 320, as indicated by the “circularly-distributed floats” (see FIG. 2C). In either case, the plurality of floats 322 oscillate relative to the central (or “support”) barge 323. The floats 322 are shaped to maximize wave radiation in to the direction of the approaching waves. Each float 322, via a respective link mechanism 333 (e.g., a slide link), drives a respective pump 326 comprising a respective piston therein (only one of which, 324, is shown). Thus, the respective floats oscillate respective pumps 326 and pressurize water in the “storage and smoothing” reservoir 328 below, which itself utilizes buoyancy chambers (BC) to aid in flotation; the reservoir 328 is also referred to as a water plenum chamber. A water turbine 330 coupled to a generator 332 via a drive shaft 332A is used for electricity generation. During piston retraction (upward movement of the pistons 324 in FIG. 2A), one-way valves 331 open, thereby allowing water intake whereas during the power stroke (downward movement of the pistons 324), the reservoir 328 is pressurized. The hinges/pivot joints are sealed and supported by bearings. Furthermore, it should be noted that the pistons 324 can operate independently, or they could be controlled to operate in unison. Should the pistons 324 oscillate out of phase, then the ability of the reservoir 328 to store pressurized water provides a way to smooth out the differences. It should be noted that it is expected that in waves that are eight times longer than the overall system 320 structure (and with regard to the circularly-distributed floats of FIGS. 2B-2C, the diameter), the pistons 324 oscillate approximately in unison.

The system 320 is an open circuit system. Phases of the oscillations are controlled with rotary motors (not shown) to control power conversion. It should also be noted that the water turbine 330 housing is shown adjacent the top exit of the reservoir 328, but it is within the broadest scope of the present invention to have a plurality of alternative locations for the actual water turbine (see FIG. 2B, for example).

It should be further noted that with regard to FIG. 2B, the diameter (ϕ)) values, as are the float dimensions (e.g., 2 m×2 m), are by way of example only and not by way of limitation.

The size of the reservoir 328 is designed to provide head stabilization in changing wave fields, while the overall device is shaped to minimize structural loads and maximize hydrostatic stability. The design of the floats 328 interacting with approaching wave fields seeks to maximize wave radiation into the direction of incoming waves, so that large power conversion is possible with small-moderate oscillations. Adjustments to the dynamic response to seek resonance and optimal damping in changing spectra may be made by controlling the torque applied by a motor (not shown, but specifically included to provide control) driving one of the rotary joints on the connecting arm (that transfers oscillation of the wave-activated float 322 to those of the reciprocating piston 324). The motor(s) may also be used to lift up the floats out of water W and lock their oscillations in stormy weather. Electric power conversion is via a generator coupled to the submerged water turbine 330. The entire system 320 may be floating and moored at a chosen location, but could be towed and relocated to different sites when needed. The system 320 can provide power for offshore applications such as long-term mid-sea salvage, repair and construction operations, but can also be located closer to shore to provide power to small islands and coastal installations. Power levels of about 20-30 kW are expected in depths in the range 20-30 m, but expansions to larger powers can be incorporated into the system 320 design at an early stage. Alternatively, multiple systems 320 can be used concurrently to provide larger power amounts. The piston housings 326A are indicated by support framework notation.

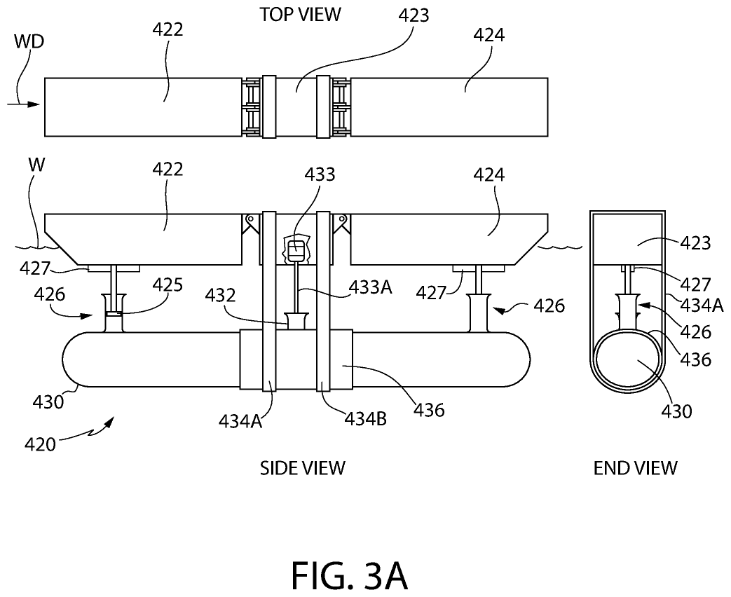

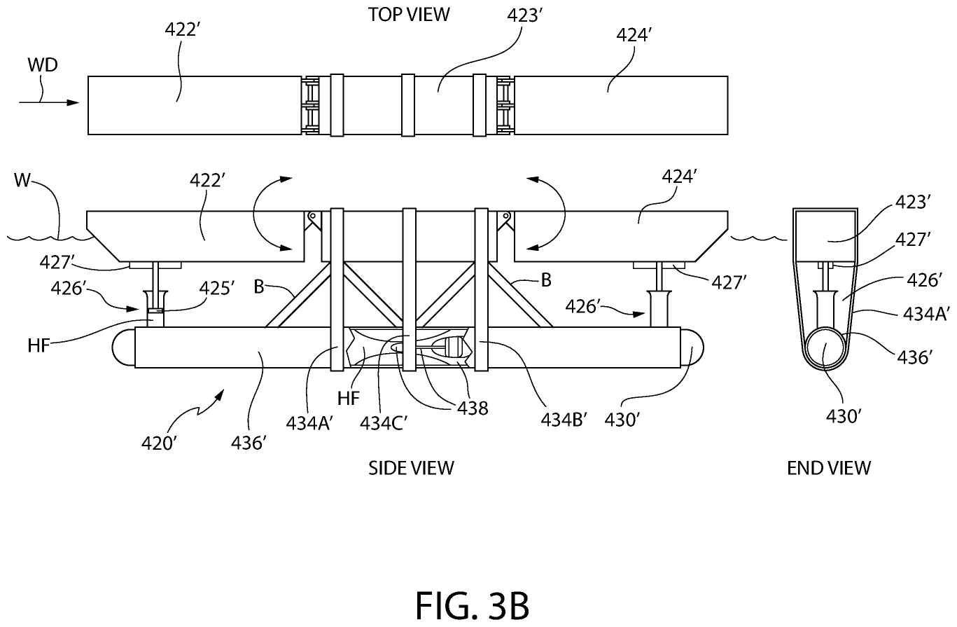

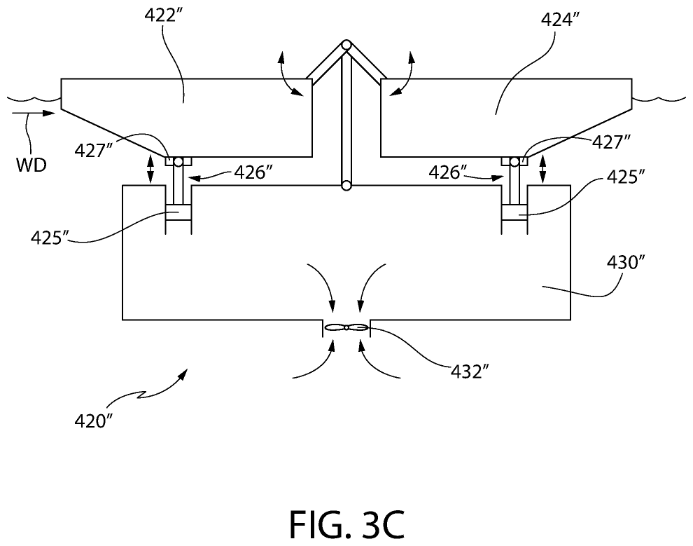

FIGS. 3A-3C depicts a system 420 that also utilizes a water-chamber/water turbine design but with a different wave energy converter system. The system 420 comprises a pair of articulating rafts/barges 422/424 pitching in response to passing waves W (as an “attenuator” system) in the wave direction WD, and in the process drives respective pumps 426 (each having a respective piston, only one 425 of which is shown; a slotted yoke 427 may connect the piston rod to the respective raft/barge 422/424) that pressurize water in the plenum chamber 430 and activate a turbine 432 for driving a generator 433 via a drive shaft 433A; the raft/barges 422/424 pivot about a central (or support) barge 423. This system 420 also has considerable radiation in a preferred direction (in-front and behind, as desired for attenuators), and the overall length of the system 420 can be designed to provide large pitch radiation damping, which is advantages to power conversion. Further, the number of hinges (though sealed and provided with bearings) in or near water is smaller than the system 320 (FIGS. 2A-2C). System 420 is also an open circuit system. Phases of the raft/barge 422/424 oscillations are controlled for power conversion control.

FIG. 3B depicts a system 420′, similar to system 420, also comprising a combination of pitching bodies with shapes optimized for radiation in a preferred direction. The reference numbers used in FIG. 3B are identical to those used with regard to FIG. 3A but utilize the prime mark to refer to FIG. 3B and hence indicate that these components operate similarly. The lengths of the two rafts/barges 422′ and 424′ (which pivot about a central or support barge 423′) are optimized for required power conversion with the water turbine 432′. However, in this system 420′, a turbo-generator system 438 is entirely contained within the reservoir 430′ (also referred to as the plenum chamber) for be driven by a pressurized hydraulic fluid HF. Various hydrodynamic design options may be used for the pitching rafts/barges 422′/424′. It is within the broadest scope of this invention 422′ to also include omni-directional configurations for the pitching rafts/barges 4227424′. The size of the system 420′ is determined such that radiation damping in pitch is large in the desired wave number range. Oscillation phases are to be controlled for power conversion control. This system 420′ is a closed-circuit system. Because the water flow through the turbine 438 reverses directions, a reversible (self-rectifying) turbine (resembling a Wells air turbine) is used. The air in the neck regions of the water-chamber wings allows some protection against large oscillations. As with the previous embodiment 420, the embodiment 420′ includes three (rather than only two) harnesses, namely, 434A′, 434B′ and 434C as well as bracing structure B for coupling the support barge 423′ with the plenum chamber 430′.

FIG. 3C depicts a system 420″ is a similar system configuration to FIG. 3A but which shows an exemplary location of the water turbine 432 and does not utilize a central barge. The reference numbers used in FIG. 3C are identical to those used with regard to FIG. 3A but utilize the double prime mark to refer to FIG. 3C and hence indicate that these components operate similarly.

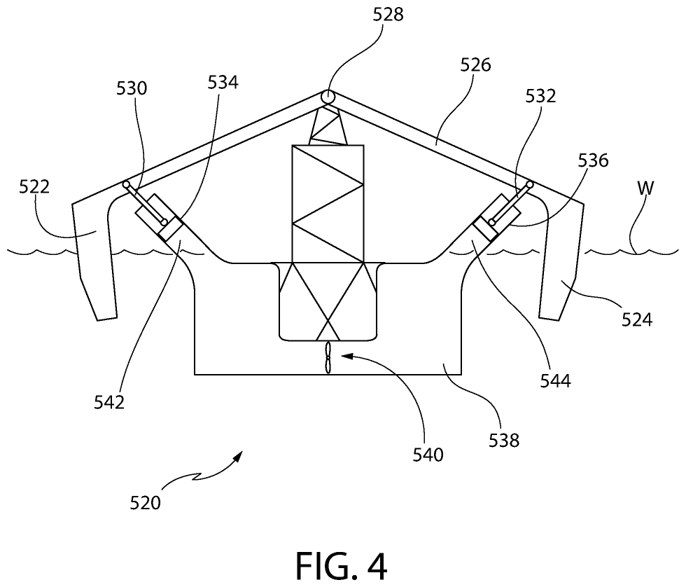

FIG. 4 depicts a system 520 comprised of a combination of pitching bodies with shapes optimized for radiation in a preferred direction. In particular, the system 520 comprises a pair of floats 522/524 coupled together in a “lever” configuration 526 at an elevated pivot point 528. Piston rams 530/532 of respective actuators 534/536 are pivotally coupled to the lever arm 526 and, as such, act in opposition to each other, as the wave motion causes one float 522 to rise and the other float 524 to fall and vice versa. The actuator cylinders are in fluid communication with a submerged chamber 538, also having turbine 540, as in systems 320 and 420. The size of the system 520 can be selected such that the radiation damping in pitch is large in the desired wave number range. Because the water flow through the turbine 540 reverses directions, a reversible (i.e., self-rectifying) turbine (resembling a Wells air turbine) is used. The air in the neck regions 542/544 of the water-chamber 538 wings allows some protection against large oscillations.

It should be understood that systems 420, 420′, 420″ and 520 are alternative approaches to performing the same goals of system 320. Each system has advantages and disadvantages and each can be evaluated through hydrodynamic modeling, simulations, operational analysis, economic analysis and storage/power distribution analysis. To avoid drive shaft bending moments due to relative oscillations between system elements spanned, provisions for sufficient compliance in mountings at each shaft end are provided. Rotary joints near the corrosive ocean environment are sealed in order to minimize risk of failure.

It should also be noted that in all of the embodiments described above, the piston/pumps may comprise bi-directional piston operation.

While the invention has been described in detail and with reference to specific examples thereof, it will be apparent to one skilled in the art that various changes and modifications can be made therein without departing from the spirit and scope thereof.

What is claimed is:

1. A system for converting wave energy from a body of water having waves into usable energy, said system comprising:
a watercraft floatable in the body of water and having an enclosure therein, said enclosure having an interior that is isolated from physical contact with the body of water;
at least one mass that is disposed in the enclosure such that it can reciprocate in motion in response to the wave energy;
a biasing means interfaced with said at least one mass that permits said at least one mass to oscillate; and
couplings connected with said at least one mass and to at least one actuator for converting said oscillation into actuator activation to pressurize a fluid or energize an electrical generator.

2. The system of claim 1 wherein said biasing means comprises at least one spring.

3. The system of claim 2 wherein said at least one mass comprises a pair of masses suspended to the enclosure via respective springs and wherein said couplings connect said pair of masses to respective actuators.

4. The system of claim 2 wherein said at least one mass comprises a plate coupled to the enclosure via a pair of springs on one side and coupled to a pivotable platform on an opposite side via a pair of actuators.

5. The system of claim 4 wherein said platform interfaces said pair of actuators with a rotatable disk and wherein activation of said actuators causes said disk to rotate.

6. The system of claim 2 wherein said at least one mass comprises a pair of masses displaceable along respective angled shafts coupled to the enclosure.

7. The system of claim 6 wherein a spring is positioned on either end of said pair of masses concentrically with said respective shafts to effect oscillation of each one of said pair of masses when wave motion is encountered.

8. A method for converting wave energy from a body of water having waves into usable energy, said method comprising:
providing a watercraft that is floatable in the body of water and having an enclosure therein, said enclosure having an interior that is isolated from physical contact with the body of water;
disposing at least one mass in the enclosure such that it can reciprocate in motion in response to the wave energy;
interfacing a biasing means with said at least one mass that permits said at least one mass to oscillate; and
connecting couplings with said at least one mass and to at least one actuator for converting said oscillation into actuator activation to pressurize a fluid or energize an electrical generator.

9. The method of claim 8 wherein said step of interfacing a biasing means comprises coupling a spring with said at least one mass.

10. The method of claim 9 wherein said step of disposing at least one mass comprises suspending a pair of masses to the enclosure via respective springs and connecting said pair of masses to respective actuators via couplings.

11. The method of claim 9 wherein said step of disposing at least one mass comprises coupling a plate to the enclosure via a pair of springs on one side and coupling an opposite side of said plate to a pivotable platform via a pair of actuators.

12. The method of claim 11 further comprising the step of interfacing a pair of actuators with a rotatable disk such that activation of said pair of actuators causes said disk to rotate.

13. The method of claim 9 wherein said step of disposing at least one mass comprises positioning a pair of masses to be displaceable along respective angled shafts which are coupled to the enclosure.

14. The method of claim 13 wherein said step of positioning said pair of masses comprises positioning a spring on either side of each one of said pair of masses concentrically with said respective shafts to effect oscillation of each one of said pair of masses when wave motion is encountered.

15. A system for converting wave energy from a body of water having waves into usable energy, said system comprising:
a plurality of floats for capturing wave energy;
a piston/cylinder associated with each float, each piston being coupled to a respective float such that wave energy causing said float to heave or pitch causes said piston to displace within said cylinder;
a water reservoir submerged in the body water and wherein each cylinder is in fluid communication with said water reservoir;
a turbine disposed across an outlet on a bottom side of said reservoir; and
activation of said piston towards said water reservoir causing the water in said water reservoir to be pressurized and rotating said turbine.

16. The system of claim 15 further comprising a generator coupled to said turbine.

17. The system of claim 15 further comprising one-way valves in said cylinder, said one-way valves opening whenever said piston retracts away from said water reservoir to draw water into said system and said one-way valves closing whenever said piston extends towards said water reservoir.

18. The system of claim 15 wherein said plurality of floats are arranged in a circular orientation for capturing wave energy omni-directionally.

19. The system of claim 18 wherein said plurality of floats comprises four floats.

20. The system of claim 15 wherein said plurality of floats comprises a pair of articulating rafts for capturing wave energy in a preferred direction.

21. The system of claim 15 wherein said plurality of floats comprises a pair of floats that are coupled together in a lever arrangement using an elevated pivot point such that the floats act in opposition.

22. A method for converting wave energy from a body of water having waves into usable energy, said system comprising:
disposing a plurality of floats in the body of water for capturing wave energy;
associating a piston/cylinder associated with each float wherein each piston is coupled to a respective float such that wave energy causes said float to heave or pitch thereby causing said piston to displace within said cylinder;
submerging a water reservoir in the body water and wherein each cylinder is in fluid communication with said water reservoir;
disposing a turbine across an outlet on a bottom side of said reservoir; and
pressurizing the water in said water reservoir by driving said piston towards said reservoir to rotate said turbine.

23. The method of claim 22 further comprising the step of coupling a generator to said turbine.

24. The method of claim 22 wherein said step of associating a piston/cylinder associated with each float comprises disposing one-way valves in said cylinder, said one-way valves opening whenever said piston retracts away from said water reservoir to draw water into said cylinder and said one-way valves closing whenever said piston extends towards said water reservoir.

25. The method of claim 22 wherein said step of disposing a plurality of floats comprises arranging said floats in a circular orientation for capturing wave energy omni-directionally.

26. The method of claim 25 wherein said circularly-oriented plurality of floats comprises four floats.

27. The method of claim 22 wherein said step of disposing a plurality of floats comprises disposing pair of articulating rafts on the body of water for capturing wave energy in a preferred direction.

28. The method of claim 22 wherein said step of disposing a plurality of floats comprises coupling a pair of floats together in a lever arrangement using an elevated pivot point such that the floats act in opposition.
